(19) United States
(12) Patent Application Publication
(10) Pub. No.: US 2011/0146574 A1
(43) Pub. Date: Jun. 23, 2011

(54) INKJET ULTRASONIC CLEANING STATION

(75) Inventors: Oleg N. GRATCHEV, San Jose, CA (US); Robert TAFF, Oakland, CA (US); David ALBERTALLI, Santa Clara, CA (US)

(73) Assignee: ULVAC, INC., Kanagawa (JP)

(21) Appl. No.: 12/975,899

(22) Filed: Dec. 22, 2010

Related U.S. Application Data
(60) Provisional application No. 61/289,696, filed on Dec. 23, 2009.

(51) Int. Cl. B05C 9/08; B05B 1/00; B05C 11/00; B08B 13/00

(52) U.S. Cl. 118/712; 118/75

(57) ABSTRACT

A microdeposition system includes a printhead carriage that includes N rows of nozzles and that moves along a first axis; a stage that holds a substrate; and a maintenance station located at a position along the first axis that is past an edge of the substrate. The N rows of nozzles selectively deposit droplets of fluid manufacturing material onto the substrate. The maintenance station includes a capping station and an ultrasonic cleaning station located in a middle of the capping station. N is an integer greater than one.

### CROSS-REFERENCE TO RELATED APPLICATIONS

This application claims the benefit of U.S. Provisional Application No. 61/289,696, filed on Dec. 23, 2009. The disclosure of the above application is incorporated herein by reference in its entirety.

### FIELD

The present disclosure relates to inkjet printing and more particularly to an ultrasonic cleaning station for inkjet printing devices.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Manufacturers have developed various techniques for fabricating microstructures that have small feature sizes. The microstructures may form one of more layers of an electronic circuit. Examples of these structures include light-emitting diode (LED) display devices, polymer LED (PLED) display devices, organic LED (OLED) devices, liquid crystal display (LCD) devices, and printed circuit boards. Many of these manufacturing techniques are relatively expensive to implement and require high production quantities to amortize the cost of the fabrication equipment.

One technique for forming microstructures on a substrate is screen printing. During screen printing, a fine mesh screen is positioned on the substrate. Fluid material is deposited through the screen and onto the substrate in a pattern defined by the screen. Screen printing therefore causes contact between the screen and the substrate. Contact also occurs between the screen and the fluid material, which contaminates both the substrate and the fluid material.

While screen printing is suitable for forming some microstructures, many manufacturing processes do not allow contamination of the substrate by the screen. Therefore, screen printing is not a viable option for the manufacture of certain microstructures. For example, polymer light-emitting diode (PLED) display devices may require a contamination-free manufacturing process.

Certain polymeric substances can be used to manufacture diodes that generate visible light of different wavelengths. Using these polymers, display devices having pixels with sub-components of red, green, and blue can be created. PLED fluid materials enable full-spectrum color displays and require very little power to emit a substantial amount of light. PLED displays can be used in various applications, including televisions, computer monitors, PDAs, other handheld computing devices, cellular phones, etc. PLED technology may also be used for manufacturing light-emitting panels that provide ambient lighting for office, storage, and living spaces. One obstacle to the widespread use of PLED display devices is the difficulty and expense of manufacturing PLED display devices.

Photolithography is another manufacturing technique that is used to manufacture microstructures on substrates. Photolithography may also be incompatible with PLED display devices. Manufacturing processes using photolithography generally involve the deposition of a photoresist material onto a substrate. The photoresist material is cured by exposure to light. A patterned mask is therefore used to selectively apply light to the photoresist material. Photoresist that is exposed to the light is cured and unexposed portions are not cured. The uncured portions can be removed from the substrate while the cured portions remain.

An underlying surface of the substrate is exposed through the removed photoresist layer. Another material is then deposited onto the substrate through the opened pattern on the photoresist layer, followed by the removal of the cured portion of the photoresist layer.

Photolithography has been used successfully to manufacture many microstructures, such as traces on circuit boards. However, photolithography contaminates the substrate and the material formed on the substrate. Photolithography may not be compatible with the manufacture of PLED displays because the photoresist contaminates the PLED polymers. In addition, photolithography involves multiple steps for applying and processing the photoresist material. The cost of the photolithography process can be prohibitive when relatively small quantities are to be fabricated. Further, expensive PLED material may be lost when it is deposited on cured photoresist that is later removed.

Spin coating has also been used to form microstructures. Spin coating involves rotating a substrate while depositing fluid material at the center of the substrate. The rotational motion of the substrate causes the fluid material to spread evenly across the surface of the substrate. Spin coating is also an expensive process because a majority of the fluid material does not remain on the substrate. In addition, the size of the substrate is limited by the spin coating process to less than approximately 12″, which makes spin coating unsuitable for larger devices such as PLED televisions.

### SUMMARY

A microdeposition system includes a printhead carriage that includes N rows of nozzles and that moves along a first axis; a stage that holds a substrate and that moves the substrate along a second axis that is perpendicular to the first axis, and a maintenance station located at a position along the first axis that is past an edge of the substrate. N is an integer greater than one. The N rows of nozzles selectively deposit droplets of fluid manufacturing material onto the substrate.

In other features, the maintenance station includes N capping chambers arranged in two groups of N/2 capping chambers. The N capping chambers simultaneously immerse the N rows of nozzles in one of a solvent and a vapor rich environment of the solvent. The maintenance station also includes an ultrasonic cleaning station located between the two groups of N/2 capping chambers. The printhead carriage rotates between first and second orientations. Each of the N rows of nozzles is parallel to the first axis when the printhead carriage is in the first orientation. Each of the N rows of nozzles is parallel to the second axis when the printhead carriage is in the second orientation. The printhead carriage rotates to the second orientation for maintenance by the maintenance station.

In further features, the ultrasonic cleaning station includes a water tank holding deionized water; ultrasonic transducers mounted to an external bottom surface of the water tank that apply ultrasonic vibrations to the deionized water; and an inner trough that is partially submerged in the water tank. The inner trough is filled with the solvent, and selectively immerses one of the N rows of nozzles in the solvent. The water tank includes a temperature sensor that measures a temperature of the deionized water. The ultrasonic transducers are deactivated when the temperature of the deionized water is greater than a threshold.

In other features, the maintenance station includes a blotting station located past the N capping chambers along the first axis. The blotting station includes a feed roller that dispenses blotting material; a waste roller that winds up the blotting material; and a spray bar that moves perpendicular to the first axis and deposits N lines of the solvent on the blotting material.

A microdeposition system includes a printhead carriage that includes N rows of nozzles and that moves along a first axis; a stage that holds a substrate; and a maintenance station located at a position along the first axis that is past an edge of the substrate. The N rows of nozzles selectively deposit droplets of fluid manufacturing material onto the substrate. The maintenance station includes a capping station and an ultrasonic cleaning station located in a middle of the capping station. N is an integer greater than one.

In other features, the stage moves the substrate along a second axis that is perpendicular to the first axis. The printhead carriage rotates between first and second orientations. Each of the N rows of nozzles is parallel to the first axis when the printhead carriage is in the first orientation. Each of the N rows of nozzles is parallel to the second axis when the printhead carriage is in the second orientation. For maintenance by the maintenance station, the printhead carriage rotates to the second orientation. For depositing the droplets on the substrate, the printhead carriage rotates to a printing orientation that is adjustable between the first orientation and a predetermined orientation. The predetermined orientation is between the first orientation and the second orientation.

In further features, the capping station includes N capping chambers. The N capping chambers simultaneously immerse the N rows of nozzles in one of a fluid and a vapor rich environment of the fluid. The fluid includes at least one of a solvent and the fluid manufacturing material. The ultrasonic cleaning station receives one of the N rows of nozzles at a time. When the one of the N rows of nozzles is placed in the ultrasonic cleaning station, remaining rows of the N rows of nozzles are outside of the N capping chambers.

In other features, the printhead carriage moves down in a direction perpendicular to the substrate to place the one of the N rows of nozzles into the ultrasonic cleaning station. The printhead carriage moves down in the direction perpendicular to the substrate to immerse the N rows of nozzles in the N capping chambers. When the one of the N rows of nozzles is placed in the ultrasonic cleaning station, one of the remaining rows of the N rows of nozzles is located between the ultrasonic cleaning station and one of the N capping chambers, and others of the remaining rows of the N rows of nozzles are located outside of the capping station. The N capping chambers are arranged in two groups of N/2 capping chambers. The ultrasonic cleaning station is located between the two groups of N/2 capping chambers.

In further features, the ultrasonic cleaning station includes a water tank that holds water; ultrasonic transducers that apply ultrasonic vibrations to the water; and an inner trough that is filled with solvent and that receives at least one of the N rows of nozzles. The ultrasonic vibrations are transferred from the water to the solvent. The inner trough is partially submerged in the water tank. The ultrasonic transducers are mounted to an external bottom surface of the water tank. The ultrasonic cleaning station further includes a temperature sensor located in the water tank that measures a temperature of the water. The ultrasonic transducers are deactivated when the temperature of the water is greater than a threshold.

In other features, the maintenance station includes a blotting station that is located at a position along the first axis that is past the capping station. The blotting station moves up along an axis perpendicular to the substrate to engage the N rows of nozzles. The blotting station moves down along the axis perpendicular to the substrate to allow use of the ultrasonic cleaning station. The blotting station moves down along the axis perpendicular to the substrate to allow manual maintenance of the N rows of nozzles.

In further features, the blotting station includes a feed roller that dispenses blotting material; a waste roller that winds up the blotting material; and a spray bar that moves perpendicular to the first axis and deposits a line of solvent on the blotting material. The spray bar deposits N lines of the solvent including the line on the blotting material.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an isometric view of an example implementation of a microdeposition system according to the principles of the present disclosure;

FIG. 2 is a simplified top view of an example implementation of a microdeposition system according to the principles of the present disclosure;

FIG. 3 is an isometric view of an example pack of printhead modules according to the principles of the present disclosure;

FIGS. 4A-4C are partial side views of an example maintenance station showing relative positions of printhead modules according to the principles of the present disclosure;

FIG. 5 is an isometric view of an example maintenance station according to the principles of the present disclosure;

FIG. 6A is an isometric view of an example ultrasonic cleaning station according to the principles of the present disclosure;

FIG. 6B is an exploded isometric view of an example ultrasonic cleaning station according to the principles of the present disclosure; and

FIG. 7 is a functional block diagram of fluid control for an example ultrasonic cleaning station according to the principles of the present disclosure.

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

The terms “fluid manufacturing material” and “fluid material,” as defined herein, are broadly construed to include any material that can assume a low viscosity form and that is suitable for being deposited, for example, from a microdeposition head onto a substrate for forming a microstructure. Fluid manufacturing materials may include, but are not limited to, light-emitting polymers (LEPs), which can be used to form polymer light-emitting diode display devices (PLEDs and PolyLEDs). Fluid manufacturing materials may also include plastics, metals, waxes, solders, solder pastes, biomedical products, acids, photoresists, solvents, adhesives, and epoxies. The term “fluid manufacturing material” is interchangeably referred to herein as “fluid material.”

The term “deposition,” as defined herein, generally refers to the process of depositing individual droplets of fluid materials on substrates. The terms “let,” “discharge,” “pattern,” and “deposit” are used interchangeably herein with specific reference to the deposition of the fluid material from a microdeposition head, for example. The terms “droplet” and “drop” are also used interchangeably.

The term “substrate,” as defined herein, is broadly construed to include any material having a surface that is suitable for receiving a fluid material during a manufacturing process such as microdeposition. Substrates include, but are not limited to, glass plate, pipettes, silicon wafers, ceramic tiles, FR-4 and other printed circuit board materials, rigid and flexible plastic, and metal sheets and rolls. In certain embodiments, a deposited fluid material itself may form a substrate, as the fluid material itself also includes surfaces suitable for receiving a fluid material during manufacturing, such as, for example, when forming three-dimensional microstructures.

The term “microstructures,” as defined herein, generally refers to structures formed with a high degree of precision, and that are sized to fit on a substrate. Because the sizes of different substrates may vary, the term “microstructures” should not be construed to be limited to any particular size and can be used interchangeably with the term “structure.” Microstructures may include a single droplet of a fluid material, any combination of droplets, or any structure formed by depositing the droplet(s) on a substrate, such as a two-dimensional layer, a three-dimensional architecture, and any other desired structure.

The microdeposition systems referenced herein perform processes by depositing fluid materials onto substrates according to user-defined computer-executable instructions. The term “computer-executable instructions,” which is also referred to herein as “program modules” or “modules,” generally includes routines, programs, objects, components, data structures, or the like that implement particular abstract data types or perform particular tasks such as, but not limited to, executing computer numerical controls for implementing microdeposition processes.

Program modules may be stored on any non-transitory, tangible computer-readable media, including, but not limited to RAM, ROM, EEPROM, CD-ROM or other optical disk storage, magnetic disk storage or other magnetic storage devices, or any other medium capable of storing instructions or data structures and capable of being accessed by a general purpose or special purpose computer.

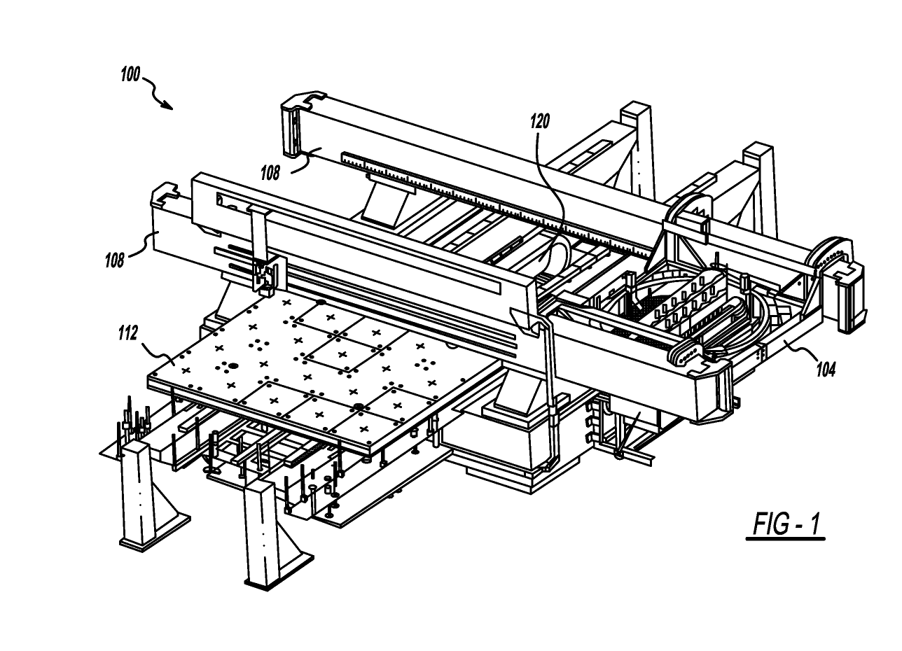

Referring now to FIG. 1, a microdeposition system 100 includes a printhead carriage 104 that slides along beams 108. For example only, the beams 108 may be constructed from granite. The direction of travel of the printhead carriage 104 may be called the x axis. The printhead carriage 104 includes one or more rows of nozzles that deposit a fluid manufacturing material on a substrate 112. For example only, the substrate 112 may be a sheet of glass and may be a component of a PLED video monitor or television.

The substrate 112 may be secured by a chuck, which may hold the substrate 112 using a vacuum. The substrate 112 may translate back and forth along the y axis, which is perpendicular to the x axis. For example only, the printhead carriage 104 may align the rows of nozzles to be parallel to the x axis. As the substrate 112 moves along the y axis, the rows of nozzles selectively deposit fluid manufacturing material onto the substrate 112. The rows of nozzles may be unable to cover the entire substrate 112 in one pass. The printhead carriage 104 may therefore translate to another position along the x axis. The substrate 112 will then move along the y axis again to print the next pass.

Alternatively, the printhead carriage 104 may print while moving along the x axis. The substrate 112 would then translate to a new position along the y axis after each pass of the printhead carriage 104 is completed. The nozzles in the printhead carriage 104 may be periodically maintained to ensure uniform dispensing of droplets. In various implementations, nozzle maintenance may be performed when the substrate 112 is being loaded into the microdeposition system 100 and/or when the substrate 112 is being unloaded from the microdeposition system 100.

A nozzle maintenance station 116 may be located further along the x axis outside of the area where printing takes place. If instead the nozzle maintenance station 116 were positioned at a location where printing was performed, such as at location 120, it may be necessary to move the nozzle maintenance station 116 below the plane of the substrate 112 in order to avoid interfering with printing.

There may be packaging constraints regarding how much room is available below the plane of the substrate. For example, portions of the chuck that holds the substrate 112 and support structures for the microdeposition system 100 may be in the way. In addition, when the nozzle maintenance station 116 would be raised to perform nozzle maintenance, loading of a new substrate may be blocked. For these reasons, the nozzle maintenance station may be located at the end of the x axis movement of the printhead carriage 104, past the area where printing takes place.

The x axis structures, including the beams 108, may need to be extended to allow for this additional x axis movement of the nozzle maintenance station 116 beyond the length needed for printing. As the length of the x axis structures increases, the overall cost, size, and weight of the microdeposition system 100 increases. The present disclosure describes techniques for reducing additional x axis travel.

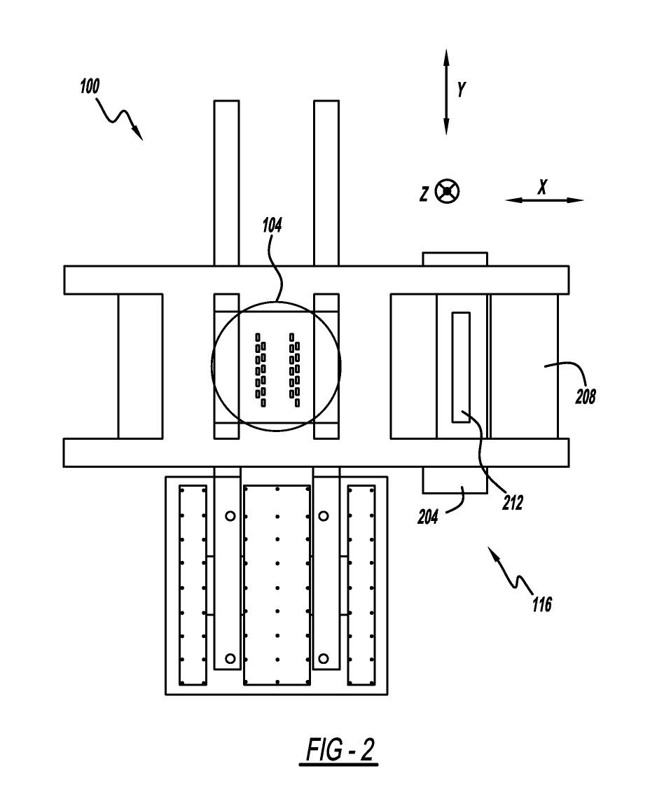

Referring now to FIG. 2, a simplified top view of the microdeposition system 100 is shown. The nozzle maintenance station 116 includes a capping station 204 and a blotting station 208. The capping station 204 may include troughs where the nozzles can be soaked to prevent the nozzles from drying out. The nozzles may be immersed in fluid or may be placed in a vapor rich environment above the fluid.

The capping station 204 may also seal the nozzles to prevent air movement from drying the nozzles. In addition, manufacturing fluids and/or solvent may be jetted from the nozzles into the capping station. This may be performed to clean the nozzles and/or when changing deposition fluids. In addition, droplet analysis may be performed while jetting droplets into the capping station 204.

For example, measurements regarding the speed, trajectory, size, and shape of droplets may be made. Deviations from desired values may be compensated for electronically and/or may result in cleaning procedures and/or other remedial measures. For example only, nozzle firing timing may be adjusted to compensate for deviations in droplet trajectory or speed. For example only, a cleaning procedure may be performed on the nozzles by the blotting station 208.

One or more nozzles may contact a blotting surface on the blotting station 208. The blotting station 208 may wipe the nozzles by moving the blotting surface while the nozzles are in contact with the blotting surface. For example only, a roll of blotting material may be dispensed from a feed roller and wound up by a waste roller. Solvent may be deposited on the blotting material to perform a wet wipe of the nozzles.

Certain manufacturing fluids may contaminate the nozzles to an extent that the contamination is not removed by the capping station 204 and the blotting station 208. In various implementations, a fluid manufacturing material may be used that is not a dispersion but a mixture of discrete particles and solvent. For example, to separate pixel regions in liquid crystal display (LCD) manufacturing, spacer particles may be mixed with solvent. When this mixture is deposited on a substrate, the solvent may be removed, such as through evaporation, leaving the spacer particles on the substrate.

For example only, spacer particles may include acrylic spheres with bonding agent applied, where the acrylic spheres have diameters between three and five microns. The spacer particles may tend to settle out of the solvent without continual ink circulation, sonification, and filtration. As such, the spacer particles may build up in low fluid flow regions or regions where natural eddy currents are present. Another cleaning station may therefore be implemented. For example, ultrasonic cleaning may release buildup of various materials in the nozzles. However, adding an ultrasonic cleaner after the blotting station 208 would require further x axis movement of the printhead carriage 104.

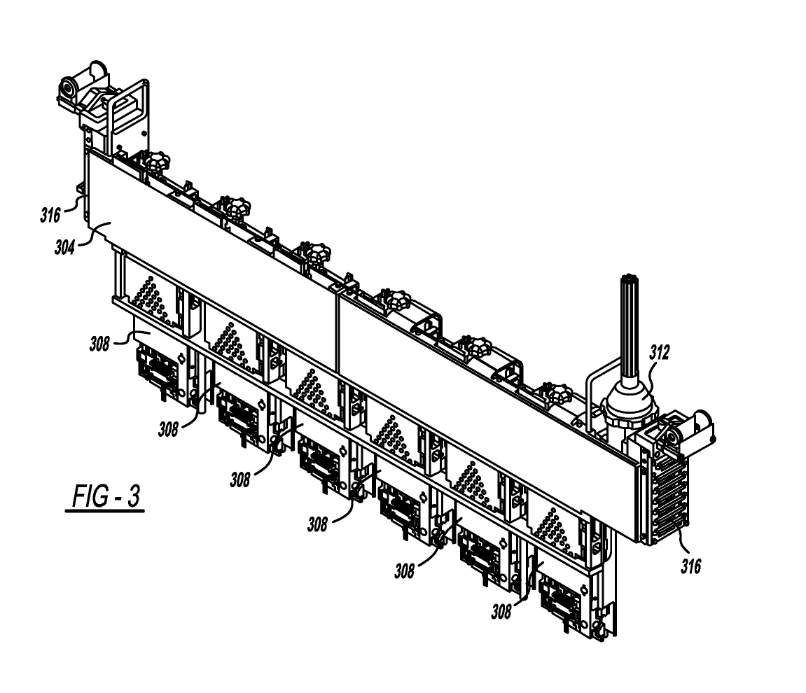

Referring now to FIG. 3, a pack 304 may include multiple printhead modules 308. Each printhead module 308 may include multiple nozzles. For example only, the pack 304 may include six printhead modules 308. Each of the printhead modules 308 may include 128 nozzles. An example implementation of the pack 304 would therefore have 6*128 (768) nozzles that are substantially colinear. Fluid for each of the printhead modules 308 may be received from a multiple-port fluid connector 312. Nozzle firing waveforms may be received via ribbon cable headers 316, which may be located at both ends of the pack 304.

Referring back to FIG. 2, an example implementation of the printhead carriage 104 may include four of the packs 304. Each of the packs is shown with six printhead modules, although more or fewer may be present. The packs 304 may be able to rotate 90 degrees, so that the rows of nozzles are perpendicular to the y axis (the direction of substrate travel) for printing and parallel to the y axis for maintenance. In addition, intermediate angles may be used to change the pitch of the nozzles with respect to the moving substrate. FIG. 2 shows the rows of nozzles being parallel to the y axis for maintenance.

When depositing solvent-suspended particles, such as spacer particles, the nozzles may be cleaned after each substrate is printed. In order to minimize production time, ultrasonic cleaning of the nozzles may be performed during the time it takes for one substrate to be unloaded and another to be loaded.

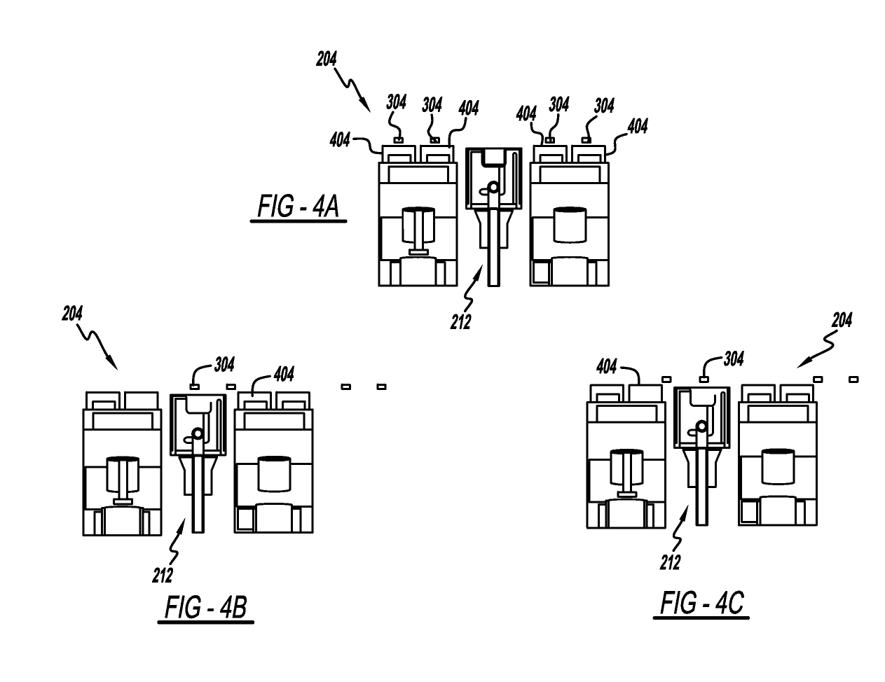

In various implementations, there may be enough time to perform four ultrasonic cleaning operations. Each of the packs may therefore be cleaned sequentially. This reduces the size of the ultrasonic cleaning assembly by approximately three-quarters. However, in order to create enough clearance for the other three packs while one pack is being cleaned, the ultrasonic cleaning station may still need to be positioned further out along the x axis. As shown in FIGS. 4A-4C, appropriately designing the spacing of the packs may allow for an ultrasonic cleaning station 212 to be located inside of the capping station 204.

Referring now to FIG. 4A, a simplified side view of the capping station 204 and the ultrasonic cleaning station 212 is shown. In an implementation where four packs 304 are present, the capping station 204 may include four capping chambers 404. Each of the packs 304 lines up with each of the capping chambers 404. The packs 304 may be lowered into the capping chambers 404 and/or the capping chambers 404 may be raised.

The ultrasonic cleaning station 212 is located between the first two of the capping chambers 404 and the second two of the capping chambers 404. In FIG. 4B, the printhead carriage has moved to position one of the packs 304 over the ultrasonic cleaning station 212. In order to submerge the pack 304 into the ultrasonic cleaning station, the packs may be lowered and/or the ultrasonic cleaning station 212 may be raised.

In various implementations, the printhead carriage 104 may have the ability to adjust the packs 304 up or down (along the z axis) to allow for varying thicknesses of substrate. The packs 304 can therefore be lowered into the ultrasonic cleaning station 212. Once lowered, one of the packs 304 will be located in the void between the ultrasonic cleaning station 212 and the second pair of capping chambers 404. The other two packs 304 are located past the capping station 204.

Similarly, when submerging a second one of the packs 304, the first one of the packs 304 will occupy the void between the first pair of the capping chambers 404 and the ultrasonic cleaning station 212, as shown in FIG. 4C. Positioning of the remaining two packs 304 in the ultrasonic cleaning station 212 may be mirror images of FIGS. 4B-4C.

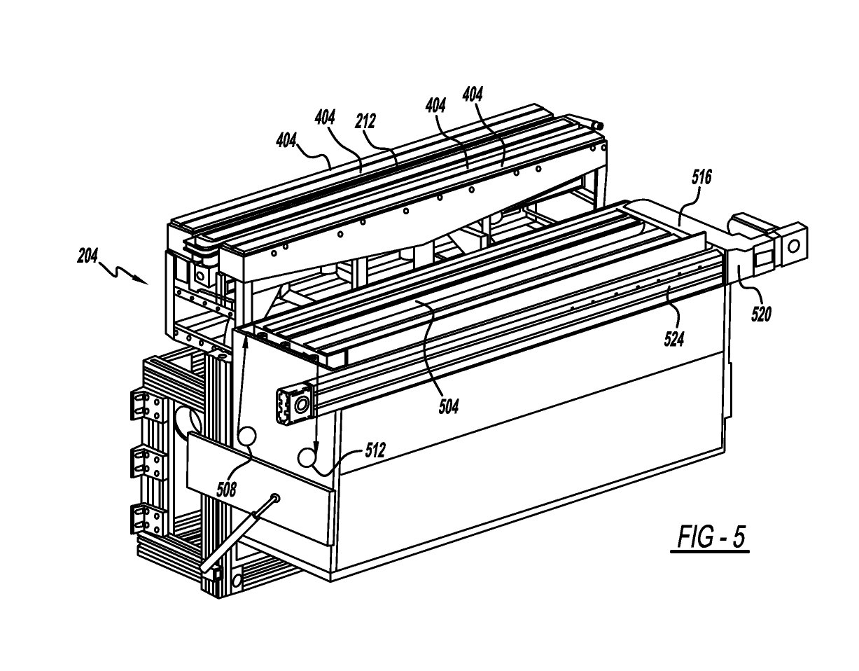

Referring now to FIG. 5, the capping chambers 404 are seen in an isometric view, with the ultrasonic cleaning station 212 located between the two sets of capping chambers 404. Because the capping station 204 surrounds the ultrasonic cleaning station 212, a vacuum that is applied by the capping station 204 to prevent evaporating solvent from escaping may also control evaporating solvent from the ultrasonic cleaning station 212. Further, the capping station 204 may provide overflow trays that capture overflow from the ultrasonic cleaning station 212.

The blotting station 208 is shown in a lowered position. This lowered position may allow for manual inspection and maintenance of nozzles and nozzle assemblies. Additionally or alternatively, as one of the packs 304 is lowered into the ultrasonic cleaning station 212, the lowered position may provide clearance for remaining ones of the packs 304. In order to perform a blotting operation, the blotting station 208 may be raised.

Blotting material 504 is drawn across the top of the blotting station. For example only, a feed roller 508 may dispense blotting material 504 and a waste roller 512 may wind up the blotting material 504. The blotting station 208 may include a spray bar 516 that sprays solvent onto the blotting material 504. In various implementations, the spray bar 516 may be mounted to a carriage 520 that rides along a rail 524 disposed parallel to the y axis. The spray bar 516 may spray solvent in four stripes, one for each of the packs.

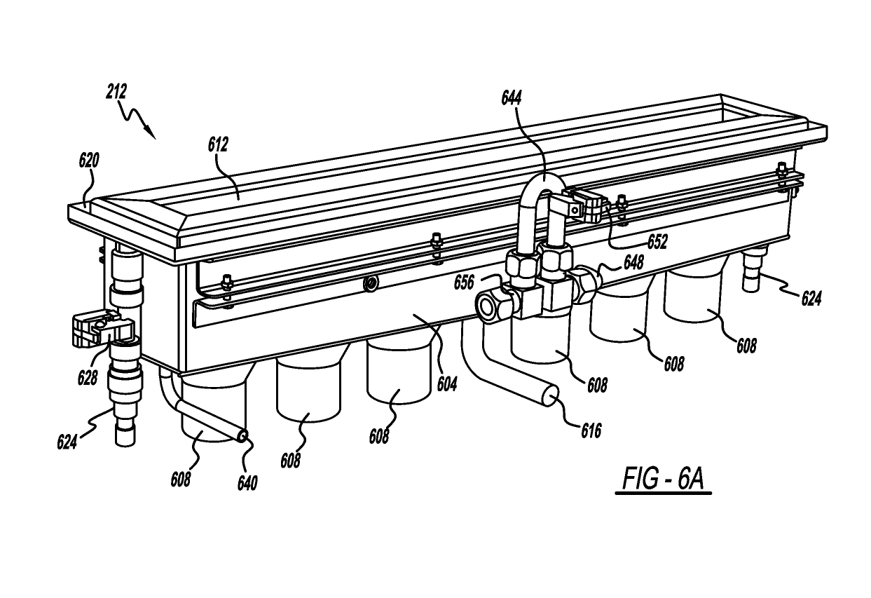

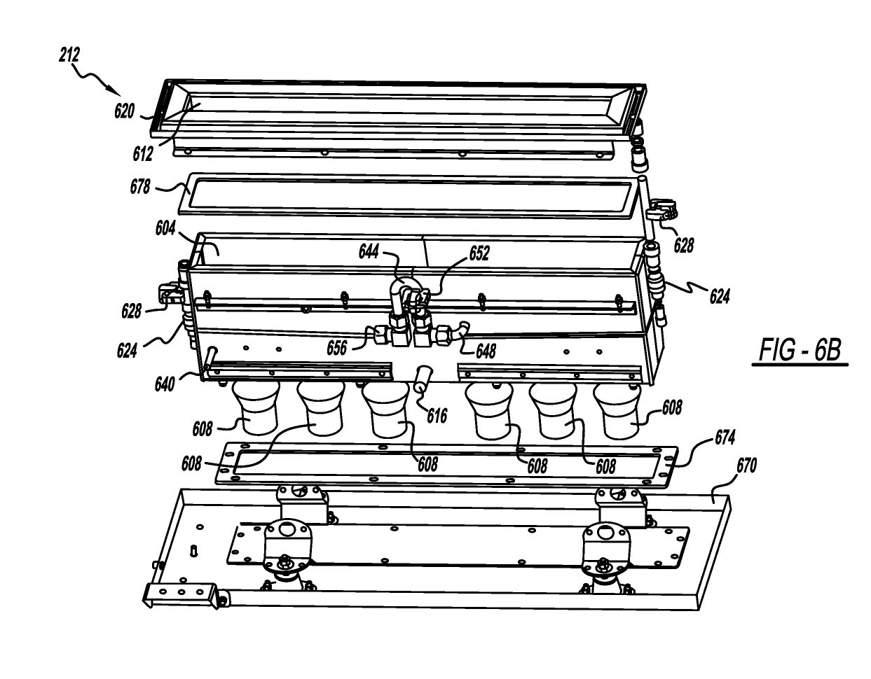

Referring now to FIG. 6A, an example of an ultrasonic cleaning station 212 includes a water tank 604 coupled to ultrasonic transducers 608. The ultrasonic transducers 608 introduce ultrasonic vibration into the water within the water tank 604. An inner solvent trough 612 contains solvent. The solvent trough 612 is partially submerged in the water of the water tank 604. Ultrasonic vibration of the water is transferred to the solvent within the solvent trough 612, into which nozzles of a pack are inserted. The ultrasonic vibration and the chemical action of the solvent remove contaminants from the nozzles.

The solvent trough 612 may be filled via a solvent inlet 616, which may pass through the water tank 604. The solvent trough 612 may be filled until solvent overflows into an overflow trough 620. The overflow trough 620 surrounds the solvent trough 612, and a solvent waste pipe 624 is present on each end of the overflow trough 620.

A fluid sensor 628 may be located on each of the waste pipes 624. The fluid sensor 628 indicates when fluid is present in the waste pipe 624. Once fluid is present in the waste pipe 624, the solvent trough 612 is determined to be full and the supply of solvent is halted.

The water tank 604 may be filled using a water fill inlet 640. In various implementations, deionized water may be used in the water tank 604. A loop 644 may be formed to detect the level of water present in the water tank 604. The loop 644 may be connected to the water tank via a coupling 648. A fluid level sensor 652 may be located near the top of the loop 644. An outlet coupling 656 may be connected to the loop 644 and may allow overflowing water to escape to an overflow tank. In addition, the outlet coupling 656 may allow trapped air to escape from the loop 644 to allow for accurate water level readings and to prevent backpressure when filling the water tank 604.

Referring now to FIG. 6B, an exploded view of the ultrasonic cleaning station 212 of FIG. 6A includes a support bracket 670. The support bracket 670 may attach to the water tank 604 via a gasket 674. In addition, a gasket 678 located between the solvent trough 612 and the water tank 604 may prevent water leakage and cross-contamination between the solvent and the water.

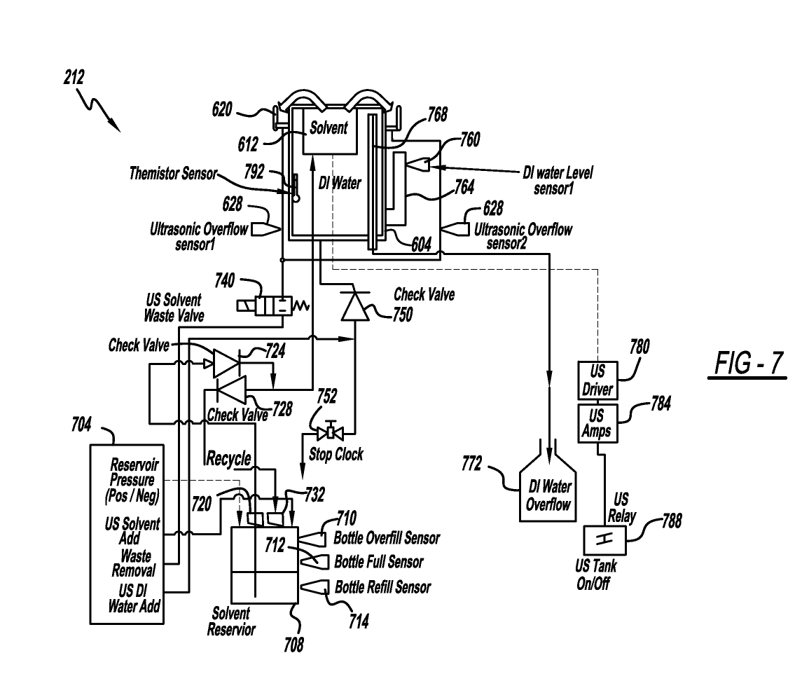

Referring now to FIG. 7, a fluid control module 704 applies pressure, which may be positive or negative, to a solvent reservoir 708. The solvent reservoir 708 may include an overfill sensor 710, a full sensor 712, and a refill sensor 714. When the refill sensor 714 does not detect fluid presence, filling of the solvent reservoir 708 begins. Filling may continue until the full sensor 712 detects fluid presence.

When the overfill sensor 710 detects fluid presence, solvent may need to be drained from the solvent reservoir 708. For example only, the solvent reservoir 708 may output solvent to the solvent trough 612, which may then overflow and be removed as waste. The solvent reservoir 708 may stop outputting the solvent when the full sensor 712 no longer detects fluid presence.

Applying pressure to the solvent reservoir 708 may push solvent through a filter 720 and then through a check valve 724 and into the solvent trough 612. Applying a negative pressure draws solvent from the solvent trough 612 to a second check valve 728 and then through a second filter 732 before the solvent returns to the solvent reservoir 708. In various implementations, solvent may be removed from the solvent trough 612 when the ultrasonic cleaning station 212 is not in use. This may minimize evaporation of solvent and also allows for the solvent to be filtered by the filters 720 and 732.

Solvent overflowing into the overflow trough 620 passes by either of the first and second fluid sensors 628 before arriving at a solvent waste valve 740. The solvent waste valve 740 may remain closed until enough solvent backs up to trip one of the fluid sensors 628. The solvent waste valve 740 may then be opened, allowing the solvent to go to a waste collection location. Alternatively, solvent from the solvent waste valve 740 may be filtered and replaced into the solvent reservoir 708.

Water may be added to the water tank 604 via a check valve 750. A stopcock 752 may allow water to be drained from the water tank 604 when the check valve 750 is bypassed. The level of water within the water tank 604 may be measured by a water level sensor 760 attached to an indicator tube 764.

An overflow tube 768 may be located within the water tank 604 to allow water to overflow to a water overflow reservoir 772 and also to allow air to escape from the water tank 604. In various implementations, the overflow tube 768 and the indicator tube 764 may be implemented in a single structure, such as the loop 644 of FIG. 6A. An ultrasound driver 780 may be driven by ultrasound amplifiers 784, which are selectively energized by a relay 788. A temperature sensor 792, such as a thermistor, may check to make sure that the water temperature does not increase above a predetermined threshold. Ultrasonic energization may be stopped if the water temperature crosses this threshold.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A microdeposition system comprising:
a printhead carriage that includes N rows of nozzles and that moves along a first axis, wherein N is an integer greater than one;
a stage that holds a substrate and that moves the substrate along a second axis that is perpendicular to the first axis, wherein the N rows of nozzles selectively deposit droplets of fluid manufacturing material onto the substrate; and
a maintenance station located at a position along the first axis that is past an edge of the substrate, wherein the maintenance station includes:
N capping chambers arranged in two groups of N/2 capping chambers, wherein the N capping chambers simultaneously immerse the N rows of nozzles in one of a solvent and a vapor rich environment of the solvent; and
an ultrasonic cleaning station located between the two groups of N/2 capping chambers, wherein:
the printhead carriage rotates between first and second orientations, wherein each of the N rows of nozzles is parallel to the first axis when the printhead carriage is in the first orientation, and wherein each of the N rows of nozzles is parallel to the second axis when the printhead carriage is in the second orientation,
the printhead carriage rotates to the second orientation for maintenance by the maintenance station,
the ultrasonic cleaning station includes:
a water tank holding deionized water;
ultrasonic transducers mounted to an external bottom surface of the water tank that apply ultrasonic vibrations to the deionized water; and
an inner trough that is partially submerged in the water tank, that is filled with the solvent, and that selectively immerses one of the N rows of nozzles in the solvent,
the water tank includes a temperature sensor that measures a temperature of the deionized water,
the ultrasonic transducers are deactivated when the temperature of the deionized water is greater than a threshold,
the maintenance station includes a blotting station located past the N capping chambers along the first axis, and
the blotting station includes:
a feed roller that dispenses blotting material;
a waste roller that winds up the blotting material; and
a spray bar that moves perpendicular to the first axis and deposits N lines of the solvent on the blotting material.

2. A microdeposition system comprising:
a printhead carriage that includes N rows of nozzles and that moves along a first axis, wherein N is an integer greater than one;
a stage that holds a substrate, wherein the N rows of nozzles selectively deposit droplets of fluid manufacturing material onto the substrate; and
a maintenance station located at a position along the first axis that is past an edge of the substrate, wherein the maintenance station includes:
a capping station; and
an ultrasonic cleaning station located in a middle of the capping station.

3. The microdeposition system of claim 2 wherein the stage moves the substrate along a second axis that is perpendicular to the first axis.

4. The microdeposition system of claim 3 wherein the printhead carriage rotates between first and second orientations, wherein each of the N rows of nozzles is parallel to the first axis when the printhead carriage is in the first orientation, and wherein each of the N rows of nozzles is parallel to the second axis when the printhead carriage is in the second orientation.

5. The microdeposition system of claim 4 wherein:
for maintenance by the maintenance station, the printhead carriage rotates to the second orientation,
for depositing the droplets on the substrate, the printhead carriage rotates to a printing orientation that is adjustable between the first orientation and a predetermined orientation, wherein the predetermined orientation is between the first orientation and the second orientation.

6. The microdeposition system of claim 2 wherein the capping station includes N capping chambers, and wherein the N capping chambers simultaneously immerse the N rows of nozzles in one of a fluid and a vapor rich environment of the fluid.

7. The microdeposition system of claim 6 wherein the fluid includes at least one of a solvent and the fluid manufacturing material.

8. The microdeposition system of claim 6 wherein the ultrasonic cleaning station receives one of the N rows of nozzles at a time.

9. The microdeposition system of claim 8 wherein when the one of the N rows of nozzles is placed in the ultrasonic cleaning station, remaining rows of the N rows of nozzles are outside of the N capping chambers.

10. The microdeposition system of claim 9 wherein:
the printhead carriage moves down in a direction perpendicular to the substrate to place the one of the N rows of nozzles into the ultrasonic cleaning station, and
the printhead carriage moves down in the direction perpendicular to the substrate to immerse the N rows of nozzles in the N capping chambers.

11. The microdeposition system of claim 9 wherein when the one of the N rows of nozzles is placed in the ultrasonic cleaning station, one of the remaining rows of the N rows of nozzles is located between the ultrasonic cleaning station and one of the N capping chambers, and others of the remaining rows of the N rows of nozzles are located outside of the capping station.

12. The microdeposition system of claim 6 wherein the N capping chambers are arranged in two groups of N/2 capping chambers, and wherein the ultrasonic cleaning station is located between the two groups of N/2 capping chambers.

13. The microdeposition system of claim 2 wherein the ultrasonic cleaning station includes:
a water tank that holds water;
ultrasonic transducers that apply ultrasonic vibrations to the water; and
an inner trough that is filled with solvent and that receives at least one of the N rows of nozzles, wherein the ultrasonic vibrations are transferred from the water to the solvent.

14. The microdeposition system of claim 13 wherein the inner trough is partially submerged in the water tank, and wherein the ultrasonic transducers are mounted to an external bottom surface of the water tank.

15. The microdeposition system of claim 13 further comprising a temperature sensor located in the water tank that measures a temperature of the water, wherein the ultrasonic transducers are deactivated when the temperature of the water is greater than a threshold.

16. The microdeposition system of claim 2 wherein the maintenance station includes a blotting station that is located at a position along the first axis that is past the capping station.

17. The microdeposition system of claim 16 wherein the blotting station moves up along an axis perpendicular to the substrate to engage the N rows of nozzles and wherein the blotting station moves down along the axis perpendicular to the substrate to allow use of the ultrasonic cleaning station.

18. The microdeposition system of claim 17 wherein the blotting station moves down along the axis perpendicular to the substrate to allow manual maintenance of the N rows of nozzles.

19. The microdeposition system of claim 17 wherein the blotting station includes:
a feed roller that dispenses blotting material;
a waste roller that winds up the blotting material; and
a spray bar that moves perpendicular to the first axis and deposits a line of solvent on the blotting material.

20. The microdeposition system of claim 19 wherein the spray bar deposits N lines of the solvent including the line on the blotting material.
